(19) United States
(12) Patent Application Publication
(10) Pub. No.: US 2008/0279177 A1
(43) Pub. Date: Nov. 13, 2008

(54) Conjoined Telephony Communication System

(76) Inventor: Eyal Shlomot, Long Beach, CA (US)

Correspondence Address: KOPPEL, PATRICK & HEYBL, 555 ST. CHARLES DRIVE, SUITE 107, THOUSAND OAKS, CA, 91360, US

(21) Appl. No.: 12/118,527

(22) Filed: May 9, 2008

Related U.S. Application Data
(60) Provisional application No. 60/928,339, filed on May 9, 2007.

(51) Int. Cl. H04L 12/66; H04J 3/16

(52) U.S. Cl. 370/352; 370/467

(57) ABSTRACT

There is provided a communication method for the receiving a first call-initiation request, generating a second call-initiation request in response to the first call-initiation request and generating a third call-initiation request in response to the first call-initiation request. Moreover, there is provided a communication method comprising receiving call-session information, separating the call-session information into core audio information and into supplementary information, routing core audio information on a first path and routing supplemental information on a second path. Further, there is provided a communication method, comprising receiving core audio information on a first communication path, receiving audio-enhancement information on a second communication path, uncompressing audio-enhancement information, combining core audio information with audio-enhancement information to generate combined audio information and providing combined audio information to audio terminals.

This application claims the benefit of U.S. Provisional Application No. 60/928,339 filed May 9, 2007.

### BACKGROUND OF THE INVENTION

1. Field of the Invention

The present invention relates to telephony communication systems, and in particular to a telephony communication system that uses routing and processing of digital and analog signals for the purpose of enabling conventional and VoIP telephony functionality by telephone terminals.

2. Background Art

Modern telephony systems use a combination of digital and analog networks and signals to deliver audio telephony, other media (e.g., video) and data communication. Today's telephony systems have evolved from the legacy Plain Old Telephony Systems (POTS), which used analog lines, switches and signals, to the modern Public Switched Telephone Networks (PSTN), which employ digital signals and switches. Recently, telephony was further expanded to the emerging Voice over Internet Protocol (VoIP) technology.

VoIP packets are used by digital telephone devices such as Internet Protocol (IP) phones, sometimes called SIP phones since they might operate in conformity with Session Initiation Protocol (SIP). There are several advantages in using VoIP networks and IP phones in comparison to PSTN networks and analog telephones. From the network point of view, VoIP provides unified network usage in carrying both audio and data by the same network and eliminating the need for separate audio and data networks. From the user/end-terminal point of view, any internet connection, wireline or wireless, can be used as a telephone connection, which can improve mobility and reduce costs. Packet communication in VoIP telephony also simplifies transmitting and receiving of additional useful information, such as caller ID, call progress and other data, which can be exchanged by the packets, whereas special signaling and tones might be needed to exchange this information in POTS or PSTN. In addition, VoIP liberates the audio communication from the traditional 4 KHz bandwidth limit of POTS and PSTN, since VoIP packets can carry audio at any bandwidth in coded formats.

VoIP can be provided with practically any IP connectivity, such as modem dial-up, Digital Subscriber Loop (DSL), TV cable modem, optical fiber or wireless connections such as WiFi or WiMAX. Since VoIP telephones utilize packet data stream carried by digital networks, while legacy analog telephones utilize analog signals carried by analog twisted pair, IP phones operate separately from legacy analog telephones. For example, in the home/home-office with a DSL connection and both analog and VoIP telephony, the analog telephones use the DSL analog connection while IP phones use the DSL digital connection. The analog connection allows all the analog telephones to share the same calling number and to naturally transfer and connect a call with each other, while the IP phones use different numbers (or SIP addresses) and are not naturally connected to all other telephones in the home/home-office.

Therefore, there is a need for a telephony system which can harmonize legacy analog telephony services with VoIP telephony to fully utilize existing and new communication channels for advanced and conjoined telephony applications.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 illustrates an analog and digital telephony with a conjoined-router implemented as conjoined-router/home in the home/home-office;

FIG. 2a illustrates an exemplary schematic flowchart of a call initiation procedure for two telephony devices in conjoined-router using SIP requests and responses, where the call is initiated by an outside caller;

FIG. 2b illustrates an alternative path of the exemplary schematic flowchart of a call initiation procedure for two telephony devices in conjoined-router using SIP requests and responses, where the call is initiated by an outside caller;

FIG. 3 illustrates an exemplary schematic flowchart of a call termination procedure for two telephony devices using SIP requests and responses;

FIG. 4 illustrates an analog and digital telephony with a conjoined-router implemented as a conjoined-router/DSLAM in the telephony exchange;

FIG. 5 illustrates a conjoined-embedded telephony configuration in the home/home-office;

FIG. 6 illustrates a schematic diagram of an embedded telephony adapter;

FIG. 7a illustrates a schematic flowchart of the operation of an embedded telephony adapter;

FIG. 7b illustrates a detail of the schematic flowchart of the operation of an embedded telephony adapter;

FIG. 8 illustrates a schematic diagram of an embedded IP phone;

FIG. 9 illustrates a schematic flowchart of the operation of an embedded IP phone;

FIG. 10 illustrates a schematic diagram of a mobile wireless embedded IP phone system;

FIG. 11 illustrates a schematic diagram of an embedded telephony adapter with WiFi;

FIG. 12 illustrates a schematic diagram of a wireless base station;

FIG. 13 illustrates a schematic diagram of a CPE device with an integrated ETA; and

FIG. 14 illustrates a schematic diagram of an embedded telephony adapter implemented as an embedded DSLAM in the telephony exchange.

### DETAILED DESCRIPTION OF THE INVENTION

The present invention is directed to a telephony communication system, which harmonizes legacy analog telephony services with VoIP telephony to fully utilize existing and new communication channels for conjoined and conjoined/embedded telephony applications. Although the invention is described with respect to specific embodiments, the principles of the invention can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

Analog and digital telephony systems carry voice and audio signals, generated and received by the users of the telephony systems, which we call audio or audio information. Telephony in general and digital telephony in particular can include other information targeted to the end users, such as video, images or graphic information, which we call other media or other-media information. The audio information and the other-media information constitute the media information, which can include audio information, other-media information or both types of information. The exchange of the media information is called a media session, where a media session can be a simple phone call between two telephone users, video call between several users, the broadcasting of audio information or other-media information from a media distribution center (e.g., a radio or TV station) to the users of telephony devices, or any other exchange of media information on the telephony network. In addition, both analog and digital telephony use signals and information for the control of the call, such as dial tones, ringing signals and tones, or call-initiation and termination commands, which we call control or protocol information. We use the term call-session information to describe together the media information and the protocol information that are used for establishing, carrying and terminating of the telephone call.

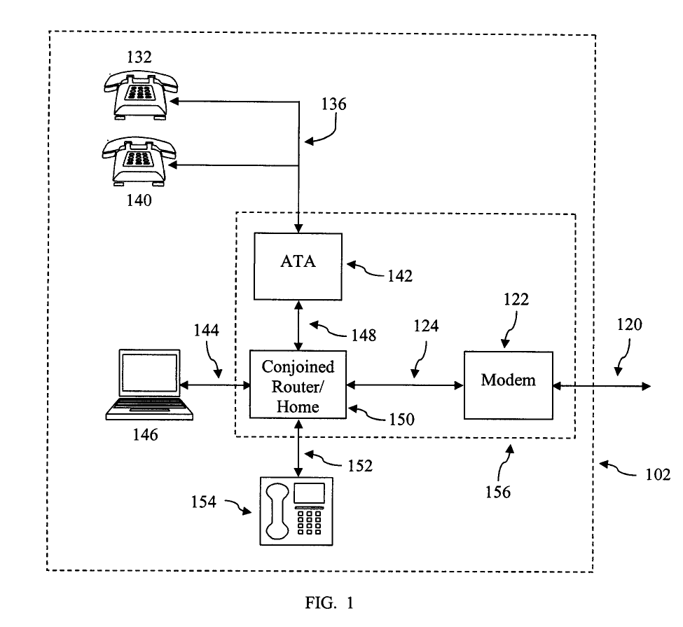

FIG. 1 illustrates an analog and digital telephony with a conjoined-router implemented as conjoined-router/home in the home/home-office in one embodiment of the present invention. Modem 122 in Home/home-office 102 is connected to a broadband connection 120. The term broadband is commonly used for high-speed internet connection, such as DSL, TV cable, optical fiber or wireless broadband (e.g. WiMAX). Therefore, modem 122 is commonly a DSL modem, a TV cable modem, a Passive Optical Network (PON) modem or a wireless modem. Modem 122 demodulates the signals from broadband connection 120 to generate local packet data stream 124. Conjoined-router/home 150 receives local packet data stream 124 and separates it into different packet streams. Data packet stream 144 is routed to computer/laptop 146, VoIP packet stream 152 is routed to IP phone 154 and local-analog-audio packet stream 148 is routed to Analog Telephone Adapter (ATA) 142. ATA 142 unpacks and uncompresses the packets in local-analog-audio packet stream 148 and provides Foreign Exchange Station (FXS) electrical signals (such as power, dial tone and ringing voltage signal) for analog telephones 132 and 140 via indoor twisted pair 136.

This approach provides VoIP technology to the home/home-office via broadband connection 120, but utilizes the existing twisted pair inside the home/home-office to provide the final-yard analog signal distribution to (existing) analog telephones 132 and 140. The calls to analog telephones 132 and 140 are perceive to be identical to tradition PSTN network calls.

For cost saving and simplicity of installation and usage, all or several functionalities of modem 122, conjoined-router/home 150 and ATA 142 can be implemented in a single device, sometimes called Customer Premise Equipment (CPE), which is represented by the encompassing dashed block 156. CPE device 156 can include other functionalities which are not explicitly described in FIG. 1, such as wireless WiFi or digital television packet data stream routing for IP TV devices.

Clearly, two separate calls can be carried by the configuration depicted in FIG. 1, one call to analog telephones 132 and 140 and another call to IP phone 154. Since both calls are carried via broadband connection 120, both calls are in conformity with digital communication protocols for VoIP call initiation, progress and termination procedures, such as, for example, Internet Engineering Task Force (IETF) Request for Comments (RFC) 3261 (SIP) or International Telecommunication Union-Telecommunication (ITU-T) Recommendation H.323 protocol, which are both hereby incorporated by reference in their entireties in the present application. A digital communication protocol for call setup procedure involves exchange of messages for the initiation, progress and termination of a call, as described, for example, by Section 4 of IETF RFC 3261 or by Section 8 of ITU-T Recommendation H.323 protocol. These communication protocols provide examples for the formats of the call-initiation protocols, the call-progress protocol and the call-termination protocol. Follows is an example of call-initiation, progress and termination procedure which uses SIP for a call initiated by an outside caller to ATA 142. The outside caller sends an “INVITE” call-initiation request, which is routed to ATA 142 based on the specific target address in the “INVITE” call-initiation request. Upon receiving a valid “INVITE” call-initiation request message from the outside caller, ATA 142 generates ringing voltage to analog telephones 132 and 140 and sends back Response Code “Ringing” (used by the calling side to generate ring-back tone to the outside caller). Once the call is answered by either analog telephone 132 or by analog telephone 140, ATA 142 detects the off-hook event from either analog telephones and sends back Response Code “OK”. Once ATA 142 receives “ACK” message from the outside caller it starts the media session. The media session consists of converting the analog signal from analog telephones 132 and/or 140 to a digital signal by an Analog-to-Digital (A/D) converter, compressing the digital signal into a bitstream, packing the bitstream into packets, and sending the packets on local-analog-audio packet stream 148, as well as unpacking incoming packets form local-analog-audio packet stream 148, uncompressing the information to generate a digital audio signal and converting the digital audio signal to an analog audio signal by a Digital-to-Analog (D/A) converter for analog telephones 132 and/or 140. The call can be received by either analog telephone 132 or 140. The call can also be transferred between analog telephones 132 and 140 by simply lifting one handset in one analog telephone and returning the second handset to its cradle. The call can also be carried simultaneously from both analog telephones as a 3-way conversation without the need of a specialized hardware or software by simply lifting both handsets from their cradles. Once the handsets of both analog telephones 132 and 140 are returned to their cradles, an on-hook event is detected by ATA 142 and triggers sending a “BYE” message, which is acknowledged by the outside caller side with Response Code “OK.” Similarly, a call can be initiated by either analog telephones 132 and 140 via ATA 142.

Similar call setup procedure can be used for a call to IP phone 154, and if it uses the same call setup protocol as ATA 142, its call setup can be identical to the call setup used by ATA 142. Some differences, however, can be in the details. In particular, the on-hook and the off-hook events, as well as the signal compressing and uncompressing and the D/A and A/D converting, are internal to the operation of IP phone 154. Moreover, IP phone 154 might provide functionality which is not provided by ATA 142. For example, if IP phone 154 is configured for wideband operation it might accept an “INVITE” message for a wideband-audio call as a valid “INVITE” message while ATA 142 might, if not configured for wideband operation, reject as invalid an “INVITE” message for a wideband-audio call.

Clearly, using VoIP packet stream 152 and local-analog-audio packet stream 148 as described above allows two simultaneous—but different and separated—phone calls; one to analog telephones 132 and 140 connected to ATA 142 via indoor twisted pair 136 and another call to IP phone 154. This configuration is becoming increasingly popular in the home/home-office, since it allows utilizing analog telephones 132 and 140 for VoIP over broadband connection 120, but its main disadvantage is the inherent separation of the calls between the analog telephones and the IP phone.

The harmonizing of the calls between the analog telephones and the IP phone is carried out by a conjoined telephony system implemented by a conjoined-router. The conjoined-router operation includes distribution and arbitration for call initiation, progress and termination messages in one embodiment of the present invention. The call-initiation requests received and generated by the conjoined-router are single-targeted call-initiation requests, which means that the call-initiation requests use a single-target call identifier, such as single SIP address, a single calling number, or apply a calling signal (such as ringing voltage) only on one telephone line. All call-initiation requests described in the sequel are single-targeted call-initiation requests.

Upon receiving the “INVITE” call-initiation request originated by an outside caller and determining that it is valid for both IP phone 154 and ATA 142, conjoined-router/home 150 “forks” the “INVITE” call initiation request by sending an “INVITE” call-initiation request to IP phone 154 via VoIP packet stream 152 and an “INVITE” call-initiation request to ATA 142 via local-analog-audio packet stream 148. The term “fork” indicates that the “INVITE” call initiation request for IP phone 154 and the “INVITE” call-initiation request for the ATA 142 are generated in response to the “INVITE” call-initiation request from the outside caller. The received “INVITE” call-initiation request and the two generated “INVITE” call-initiation requests might be identical, but they might also be different, since IP phone 154 and ATA 142 might use different call setup protocols and might have different capabilities. Per the required setup in the particular home/home-office, conjoined-router/home 150 can generate Response Code “Ringing” if at least one of IP phone 154 or ATA 142 sends back Response Code “Ringing” (at least one phone is ringing), or only when both IP phone 154 and ATA 142 send back Response Code “Ringing” (all phones are ringing). Similarly, per the required application, conjoined-router/home 150 can generate Response Code “OK” if either IP phone 154 or ATA 142 sends back Response Code “OK” (at least one phone is picked up), or only when both IP phone 154 and ATA 142 send back Response Code “OK” (IP phone picked up and at least one analog telephone is picked up).

Once an “ACK” message arrives to conjoined-router/home 150 from the outside caller, signaling that the call setup was completed and the beginning of the media session, conjoined-router/home 150 operates as either an arbitration media router or as a conferencing bridge.

If Response Code “OK” was received only from ATA 142, conjoined-router/home 150 will carry a two-way media session only between ATA 142 and the outside caller, while if Response Code “OK” was received only from IP phone 154, conjoined-router/home 150 will carry a two-way media session only between IP phone 154 and the outside caller. Carrying a two-way media session with each individual device requires arbitration routing the media information packets (such as the audio packets) from the outside caller to the individual device and routing the media information packets from the individual device to the outside caller.

If Response Code “OK” was received from both ATA 142 and IP phone 154, conjoined-router/home 150 will carry a three-way media session between the outside caller, ATA 142 and IP phone 154, for example, by operating as a conference bridge. The operation of the conference bridge includes the decoding of the three incoming bitstreams into three decoded audio signals as input audio signals to a mixer, mixing the input audio signals into three output audio signals by the mixer, encoding the three output audio signals into three outgoing bitstreams, which are then sent to each of the three directions—ATA 142 (delivered to analog telephones 132 and 140), IP phone 154 and modem 122 (sent to the outside caller).

More elaborated control of the call might be required for the management of various media (audio and/or video) streaming, as well as full control of all aspects of the call. For example, a “CANCEL” or similar command can be issued by conjoined-router/home 150 to IP phone 154 if Response Code “OK” was first received from ATA 142 to terminate the ringing of IP phone 154 once the call is answered by ATA 142 (or vice versa). Conjoined-router/home 150 should also handle calls originated from either ATA 142 or IP phone 154, as well as manage the distribution of call data information for ATA 142 and IP phone 154, such as caller ID or call progress information.

Termination of the call by either devices is the reverse of the call setup procedure described above, using the “BYE” message and the Response Code “OK”. However, conjoined-router/home 150 should manage the exchange of control messages with the outside caller, based on the status and messages from ATA 142 and IP phone 154. For example, if the call was transferred from ATA 142 to IP phone 154, conjoined-router/home 150 might have sent Response Code “OK” to the outside caller based on receiving Response Code “OK” from ATA 142 at the beginning of the call, but sends “BYE” request to the outside caller based on “BYE” request from IP phone 154 at the end of the call.

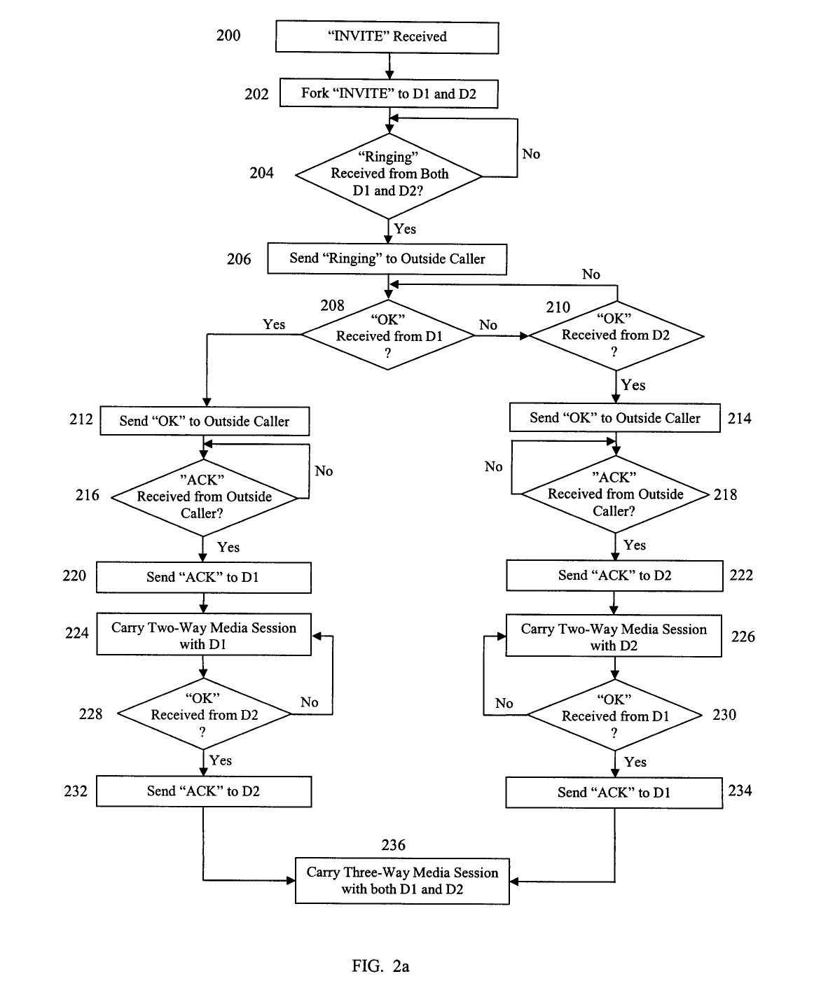

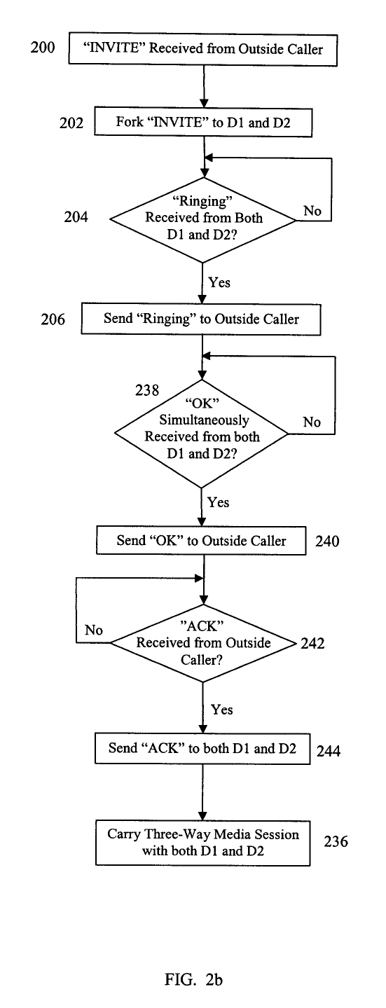

FIGS. 2a and 2b illustrate an exemplary schematic flowchart of a call initiation procedure in conjoined-router/home 150 for two telephony devices using SIP requests and responses where the call is initiated by an outside caller in one embodiment of the present invention. The telephony devices in FIGS. 2a and 2b are denoted by D1 and D2, since they represent any two telephony devices that are in conformity with SIP. For example, D1 can represent ATA 142 and D2 can represent IP phone 154. The example in FIGS. 2a and 2b assumes that it is sufficient to answer the call by any of the telephony devices, as common in a home/home-office environment. The call-initiation request by the outside caller involves sending a single-targeted call-initiation request, such as the “INVITE” call-initiation with the SIP identity described by the SIP's Uniform Resource Identifier (URI). In FIG. 2a, upon receiving an “INVITE” call-initiation request from outside caller in execution step 200, the “INVITE” call-initiation request is forked to both D1 and D2 devices in execution step 202 by generating one “INVITE” call-initiation request to D1 and generating another “INVITE” call-initiation request to D2. Decision step 204 waits for Response Code “Ringing” messages from both devices D1 and D2, generated by each device in response to its received “INVITE” call-initiation request. (Another possibility is to wait for Response Code “Ringing” from either D1 or D2, which can be more practical if any of the devices is disconnected at times.) After receiving Response Code “Ringing” from D1 and D2, Response Code “Ringing” is sent to outside caller in execution step 206 and decision step 208 waits for Response Code “OK” from D1, while decision step 210 waits for Response Code “OK” from D2.

If Response Code “OK” is received from D1 in decision step 208, Response Code “OK” is sent to outside caller in execution step 212. Once “ACK” message is received from outside caller in decision step 216, “ACK” message is sent to D1 in execution step 220 and a two-way media session between the outside caller and D1 is carried in execution step 224. Once Response Code “OK” is received from D2 is decision step 228, “ACK” message is sent to D2 in execution step 232 and a three-way media session between the outside caller, D1 and D2 is carried is execution step 236.

If Response Code “OK” is received from D2 in decision step 210, Response Code “OK” is sent to outside caller in execution step 214. Once “ACK” message is received from outside caller in decision step 218, “ACK” message is sent to D2 in execution step 222 and a two-way media session between the outside caller and D2 is carried in execution step 226. Once Response Code “OK” is received from D1 is decision step 230, “ACK” message is sent to D1 in execution step 234 and a three-way media session between the outside caller, D1 and D2 is carried in execution step 236.

FIG. 2b demonstrates an alternative path of the exemplary schematic flowchart, when Response Codes “OK” are received simultaneously from D1 and D2. Steps 200, 202, 204 and 206 are identical to the corresponding execution steps in FIG. 2a. Simultaneously receiving of Response Codes “OK” from both D1 and D2 is defines as the arriving of the later Response Code “OK” from a device before a two-way media session is established between the outside caller and the other device (i.e., the device that sent the earlier-received Response Code “OK”). If Response Codes “OK” are received simultaneously from both D1 and D2 in decision step 238, Response Code “OK” is sent to outside caller in execution step 240. Once “ACK” message is received from outside caller in decision step 242, “ACK” message is sent to both D1 and D2 in execution step 244 and a three-way media session between the outside caller, D1 and D2 is carried in execution step 236. It should be noted that the process of sending Response Code “OK” to outside caller can start based on receiving Response Code “OK” only from one device and that three-way media session can start, without an intermediate two-way media session, as long as the second Response Code “OK” is received before the intermediate two-way media session has started. Naturally, decision step 238 in FIG. 2b and decisions steps 208 and 210 in FIG. 2a are conducted together and the separation of the operation between FIGS. 2a and 2b was done only for the convenience of the presentation.

To stop D2 from continue ringing if the call was answered by D1, execution step 220 might also send a “CANCEL” message to D2. Similarly, execution step 222 might send a “CANCEL” message to D1. In such a case, when a second talker wants to join the call from D2 or from D1, the “OK” message from D2 in decision step 228 might be actually an “INVITE” message from D2. Similarly, the “OK” message from D1 in decision step 230 might be actually an “INVITE” message from D1. Since either an “OK” message or an “INVITE” message indicate the joining of the second device to the media session carried by the other device, both result in a combined three-way media session by execution step 236.

In FIGS. 2a and 2b, the “INVITE” call-initiation request stands for a general single-targeted call-initiation request of any protocol, “OK” stands for a general acceptance message of any protocol for the “INVITE” single-targeted call-initiation request and “ACK” stands for a general acknowledge message of any protocol for the “OK” acceptance message. Although the specific SIP names for the protocol messages are used in the example, other protocol messages can be used and are within the knowledge of a person of ordinary skill in the art.

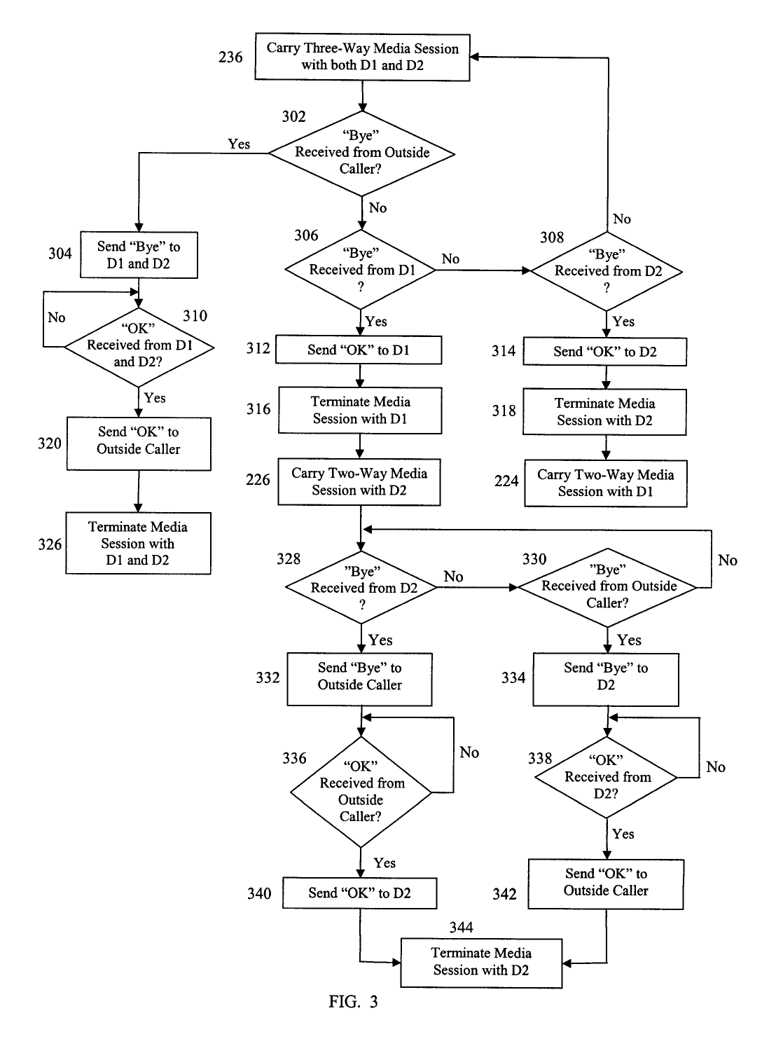

FIG. 3 outlines an exemplary schematic flowchart of a call termination procedure for two telephony devices using SIP requests and responses in one embodiment of the present invention. Similar to FIGS. 2a and 2b, the telephony devices are denoted by D1 and D2, since they can represent any two telephony devices that are in conformity with SIP, where, for example, D1 can represent ATA 142 and D2 can represent IP phone 154. The three-way media session between the outside caller and both D1 and D2 is carried in execution step 236, as described in FIGS. 2a and 2b. Decision step 302 checks if a “BYE” call-termination request was received from the outside caller. If a “BYE” call-termination request was not received from the outside caller, decision step 306 checks if a “BYE” call-termination request was received from D1 and decision step 308 checks if a “BYE” call-termination request was received from D2. If the “BYE” call-termination requests were not received from either the outside caller, D1 or D2, the media session is carried continually in execution step 236. If a “BYE” call-termination request is received from the outside caller in decision step 302, a “BYE” call-termination request is sent to D1 and D2 in execution step 304, and their “OK” responses are received in decision step 310. Once the “OK” responses are received, “OK” response is sent to outside caller in execution step 320 and the three-way media session between the outside caller, D1 and D2 is terminated in execution step 326. If a “BYE” call-termination request is received from D1 in decision step 306, an “OK” response is sent to D1 in execution step 312 and the media session with D1 is terminated in execution step 316, while a two-way media session between the outside caller and D2 is carried continually in execution step 226. Similarly, if a “BYE” call-termination request is received from D2 in decision step 308, an “OK” response is sent to D2 in execution step 314 and the media session with D2 is terminated in execution step 318, while a two-way media session between the outside caller and D1 is carried continually in execution step 224.

Once execution steps 226 or 224 are reached, the media session is carried between the outside caller and only a single telephony device. In that situation, the other telephony device can join (or rejoin) the call, as described in FIG. 2a, or the media session between the outside caller and the single telephony device can be terminated, following a standard signaling and handshaking procedure. For clarity of the presentation, this standard signaling and handshaking procedure is described in FIG. 3 for D2 only, starting from execution step 226. An identical procedure (not shown) applies to D1 starting from execution step 224. The procedure includes waiting for “BYE” call-termination requests from either D2 or the outside caller in decision steps 328 and 330, forwarding the “BYE” call-termination request to the other side in execution steps 332 or 334 and waiting to the “OK” response of other side in decision steps of 336 or 338. Once the “OK” response is received, the procedure continues by forwarding the “OK” response to the call-termination requesting side in execution steps 340 or 342, and finally terminating the media session between the outside caller and D2 in execution step 334.

In FIG. 3, the “BYE” call-termination request stands for a general call-termination message of any protocol and the “OK” request stands for a general acceptance message of any protocol for the “BYE” call-termination request. Although the specific SIP names for the protocol messages are used in the example, other protocol messages can be used and are within the knowledge of a person of ordinary skill in the art.

Moreover, it is possible that different call initiation procedures are used by different telephony devices inside home/home-office 102 and yet another different call initiation procedure is used by the outside caller. In such a case, the execution of the steps in FIGS. 2a, 2b and 3 might include converting and matching between the different call initiation and termination procedures and protocols. For example, the “ACK” message received from the outside caller in decision step 216 in FIG. 2a can conform to a first call-initiation protocol while the “ACK” message sent to D1 in execution step 220 can conform to a second call-initiation protocol. In another example, the “BYE” call-termination request received from the outside caller in decision step 302 in FIG. 3 can conform to a first call-termination protocol while the “BYE” call-termination requests sent to D1 and D2 in execution step 332 can conform to a second call-termination protocol and a third call-termination protocol, respectively.

The call initiation procedure illustrated in FIGS. 2a and 2b and the call termination procedure illustrated in FIG. 3 can be readily extended to more than two telephony devices. Further, the audio packets from each source can include narrowband audio or wideband audio and the media session can be performed as either a narrowband media session or a wideband media session. Moreover, if needed, the media session can include bandwidth conversion procedures to allow different devices to operate at a different bandwidth. The control of several telephony devices can include additional service options. For example, one service option can provide a special telephone number (or SIP URI) for each device and another telephone number (or SIP URI) for a group of devices. A practical example can be when ATA 142 serves the living area of the home while IP phone 154 serves the home-office area. In that case, a first number can be assigned such that when this first number is called, the call is routed to ATA 142, a second number (or SIP URI) can be assigned which is routed to IP phone 154, while yet a third number is assigned such that when this third number is called the call is routed to both ATA 142 and IP phone 154 and conjoined-router/home 150 conjointly connects both telephony devices with the outside caller and with each other as described above.

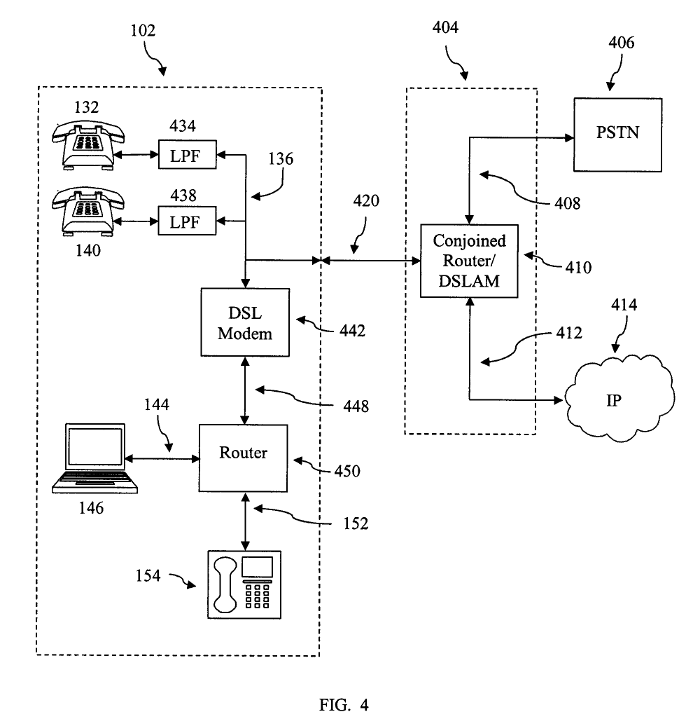

FIG. 4 illustrates an analog and digital telephony with a conjoined-router implemented as a conjoined-router/DSL-Access-Multiplexer (DSLAM) in the telephony exchange in one embodiment of the present invention. Conjoined-router/DSLAM 410 is connected to both PSTN network 406 and IP network 414. PSTN network 406 commonly transmits/receives PSTN telephony signal 408, while IP network 414 commonly transmits/receives IP packet stream 412. Conjoined-router/DSLAM 410 encodes and modulates IP packet stream 412 and sends it using high-frequency modulated analog carrier signals over outdoor twisted pair 420, which is connected to indoor twisted pair 136. Conjoined-router/DSLAM 410 also sends the low-band audio telephony signals as analog signals over outdoor twisted pair 420 toward indoor twisted pair 136. (Conjoined-router/DSLAM 410 can include or be connected to aggregation cards and/or line cards, not shown, which generate FXS functionalities for telephony exchange 404.)

DSL modem 442 is connected to outdoor twisted pair 420 via indoor twisted pair 136. It receives the high-band modulated analog carrier signals and demodulates and decodes them to generate local IP packet stream 448, which is routed by router 450 as data packet stream 144 to computer/laptop 146 and used, for example, for the display of web pages. In addition, VoIP packet stream 152 to and from IP phone 154 is exchanged with conjoined-router/DSLAM 410 via router 450 and DSL modem 442. Analog telephones 132 and 140 are connected to indoor twisted pair 136 via low-pass filters 434 and 438, respectively. Low-pass filters 434 and 438 filter-out and remove the high-band modulated analog carrier signals used between DSL modem 442 and conjoined-router/DSLAM 410, allowing the users of analog telephones 132 and 140 to hear only the low-band audio telephony signals. The analog path to send and receive the analog audio signals between analog telephones 132 and 140 to conjoined-router/DSLAM 410 includes low-pass filters 434 and 438, indoor twisted pair 136 and outdoor twisted pair 420. Analog telephones 132 and 140 can be wireline analog telephones, but can also be analog or digital cordless phones that interact with conjoined-router/DSLAM 410 as analog telephones.

The call initiation, termination and the carrying of media sessions between analog telephones 132 and 140 and IP phone 154, described in FIGS. 2a, 2b and 3, can be performed by conjoined-router/DSLAM 410 in telephone exchange 404. In particular, since the analog telephones use electrical signals, rather than digital protocol message, the application or the detection of these electrical signals by the aggregation and/or line cards is equivalent to the sending or receiving of the equivalent protocol messages. For example, sending the “INVITE” call-initiation toward the analog telephones in execution step 202 in FIG. 2a is simply the applying of the ringing electrical signal by the aggregation and/or line cards toward the analog telephones, the “OK” response received in decision steps 208 or 210 in FIG. 2a is simply the detection of the off-hook event by the aggregation and/or line cards, and the receiving of the “BYE” call-termination request in decision steps 306 or 308 is simply the detection of the on-hook event by the aggregation and/or line cards.

The other advanced call setups and configurations described above can be executed by conjoined-router/DSLAM 410 in telephone exchange 404. For example, a call to one number from PSTN network 406 can be routed to analog telephones 132 and 140, a call to second number (or SIP URI) from IP network 414 can be routed to IP phone 154, while for a third number (or SIP URI) from PSTN network 406 (or IP network 414), conjoined-router/DSLAM 410 can fork that single-targeted call-initiation request to all telephony devices and connects between all telephony devices, including all aspects of call initiation, carrying of the media session and call termination, as well as advanced telephony features such as data distribution and video communication.

The call initiation, progress and termination, as well as the media session approaches describe above provide conjoined usage of several telephony devices in the home/home-office environment with various network interfaces. However, this approach still has two main disadvantages in comparison to the simple and natural usage of legacy analog telephony devices. The first disadvantage is the complicated conference mixing and call transfer needed to be implemented in the conjoined-router/home or the conjoined-router/DSLAM in order to bridge between several telephony devices, in comparison to the natural mixing and ease of call transfer for legacy analog telephony devices. The second disadvantage is that ATA devices and IP phones might require special wiring for network connection. Such network wiring is not common in a typical home/home-office, which is usually wired with indoor twisted pair that connects the outdoor twisted pair with several phone jacks on the walls.

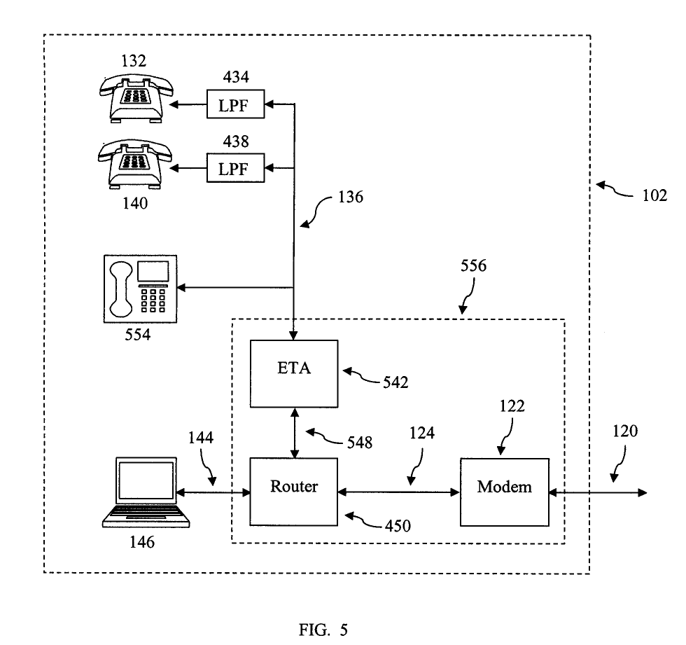

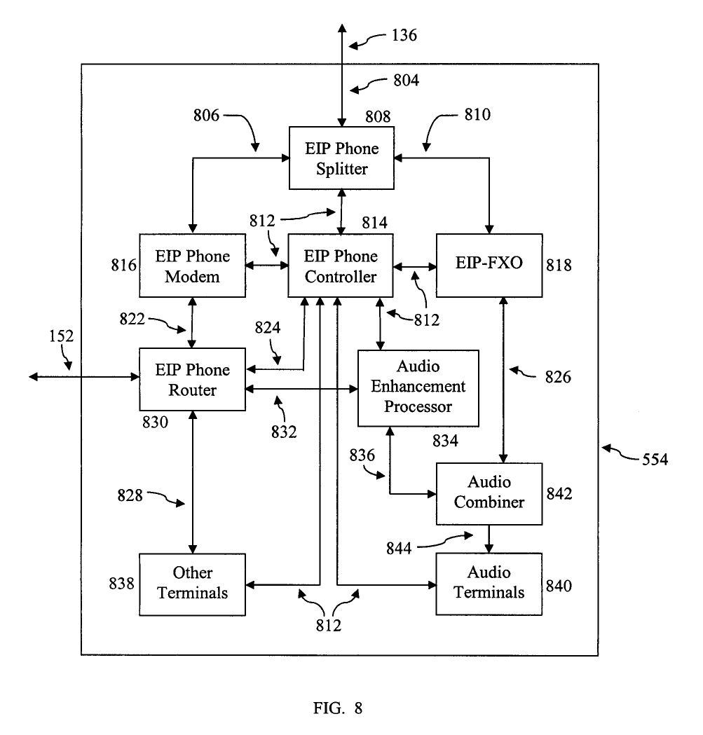

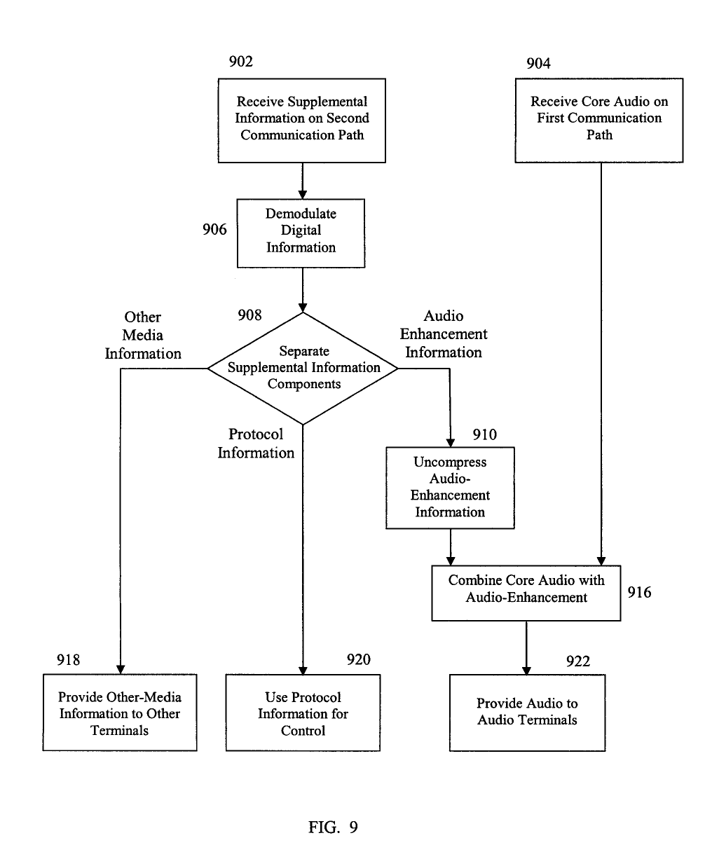

These problems can be resolved by a conjoined-embedded telephony communication approach, in which enhancement communication layers are built on top of a core communication layer. FIG. 5 illustrates a conjoined-embedded telephony system in the home/home-office 102 connected by broadband connection 120, which can be, for example, DSL connection, TV cable, optical fiber or WiMAX connection in one embodiment of the present invention. Broadband connection 120 is fed into modem 122, which demodulates and decoded the broadband signal to generate local packet data stream 124. Local packet data stream 124 is received by router 450, which distributes the packets to their different targets, such as computer data packet stream 144 to computer/laptop 146 and telephony packet stream 548 to Embedded Telephony Adaptor (ETA) 542. Modem 122, router 450 and ETA 542 can be implemented within single device 556, which can include other functionalities such as wireless WiFi module or routing of digital television packet stream to IP TV devices, not shown in FIG. 5. During a call carried by ETA 542, telephony packet stream 548 includes protocol information and media information, constituting the call-session information. The protocol information contains call initiation and termination requests and responses, as well as other information such as caller ID and call progress information. The media information contains coded audio information, coded video or any other media information for the end user (e.g., graphical or pictorial information). In particular, the audio information in the packets might include core audio information and audio-enhancement information, where the core audio information is the information sufficient to describe and generate the audio signals and the audio-enhancement information is the information which can be used to enhance the quality of the audio signals. The core audio information might comprises of lower-frequencies or lower-bitrates coded audio and the audio-enhancement information might comprises of higher-frequencies or higher-bitrates coded audio, as described, for example, by ITU-T Recommendation G.729.1, which is hereby incorporated by reference in its entirety in the present application. We use the term supplemental information to describe the protocol, other-media and audio-enhancement information, differentiating it from core audio information. ETA 542 decodes the coded core audio information into core audio samples which are converted by a D/A converter to generate core analog audio signals on indoor twisted pair 136. The core analog audio signals on indoor twisted pair 136 occupy only the low spectral band. The supplemental information packets are encoded and modulated in the higher spectral bands, similar to DSL. However, this approach is different from DSL, since the low spectral band carries the core analog audio signal of a telephone call conducted through EAT 542, while the higher spectral bands carry the supplemental information of the same telephone call conducted through ETA 542. Analog telephones 132 and 140 are connected to indoor twisted pair 136 via low-pass filters 434 and 438, respectively. Low-pass filters 434 and 438 filter-out the modulated digital signals at the higher spectral bands, allowing only the lower band core analog audio signal to reach analog telephones 132 and 140. Embedded IP phone 554 is also connected to ETA 542 via indoor twisted pair 136. Detailed descriptions of the structure and the method of operation of embedded IP phone 554 are provided in FIGS. 8 and 9.

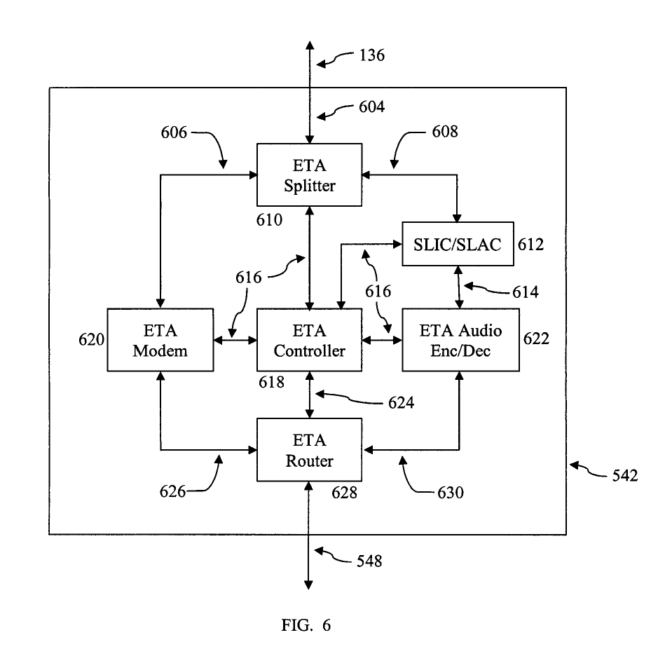

FIG. 6 illustrates a schematic diagram of embedded telephony adapter 542 in one embodiment of the present invention. For the sake of clarity of presentation, the term “signal” (or “stream”) is used to describe both the signals and the lines which carry these signals between one component to the other.

In the direction from the packet stream to the analog path, telephony packet stream 548, which carries all of the call-session information, is received and its components are separated and routed by ETA router 628 according to the packets content and destination, whereas the core audio information is routed on core audio packet path 630 to ETA audio Encoder/Decoder (Enc/Dec) 622 and the supplemental information is routed on supplemental packet path 626 to ETA modem 620. ETA audio Enc/Dec 622 unpacks the packets on core audio packet path 630 to extract the bitstream and uncompresses the bitstream to produce core digital audio signal 614. Core digital audio signal 614 is converted to core analog audio signal 608 by the D/A converter in SLIC/SLAC (Subscriber Line Interface Controller/Subscriber Line Access Controller) 612. Further, ETA modem 620 modulates the supplemental information from supplemental information packet path 626 to generate and send analog modulated signal 606. ETA splitter 610 combines core analog audio signal 608 with analog modulated signal 606 to generate combined analog signal 604. Combined analog signal 604 is transmitted and received from indoor twisted pair 136, as depicted in FIG. 5.

In the direction from the analog path to the packet stream, ETA splitter 610 splits combined analog signal 604 to generate core analog audio signal 608 and analog modulated signal 606. SLIC/SLAC 612 receives core analog audio signal 608 and generates core digital audio signal 614 by its A/D converter. Core digital audio signal 614 is compressed to a packet bitstream by ETA audio Enc/Dec 622 to generate the packets on core audio packet path 630. ETA modem 620 demodulates analog modulated signal 606 to generate the packets on supplemental information packet path 626. The packets on core audio packet path 630 and on supplemental information packet path 626 are received by ETA router 628 to generate telephony packet stream 548.

ETA splitter 610 operates, for example, according to Figure E.2/G.992.1 in ITU-T Recommendation G.992.1, which is hereby incorporated by reference in its entirety in the present application. Since core analog audio signal 608 occupies only the low spectral band while analog modulated signal 606 occupies only the higher spectral bands, both can be used to construct combined analog signal 604 without interfering with each other, similar to the well known DSL technology.

ETA controller 618 exchanges control packet stream 624 with ETA router 628 and uses them to control the functionality of all other modules in ETA 602 via several internal control lines 616 and with the outside caller via telephony packet stream 548.

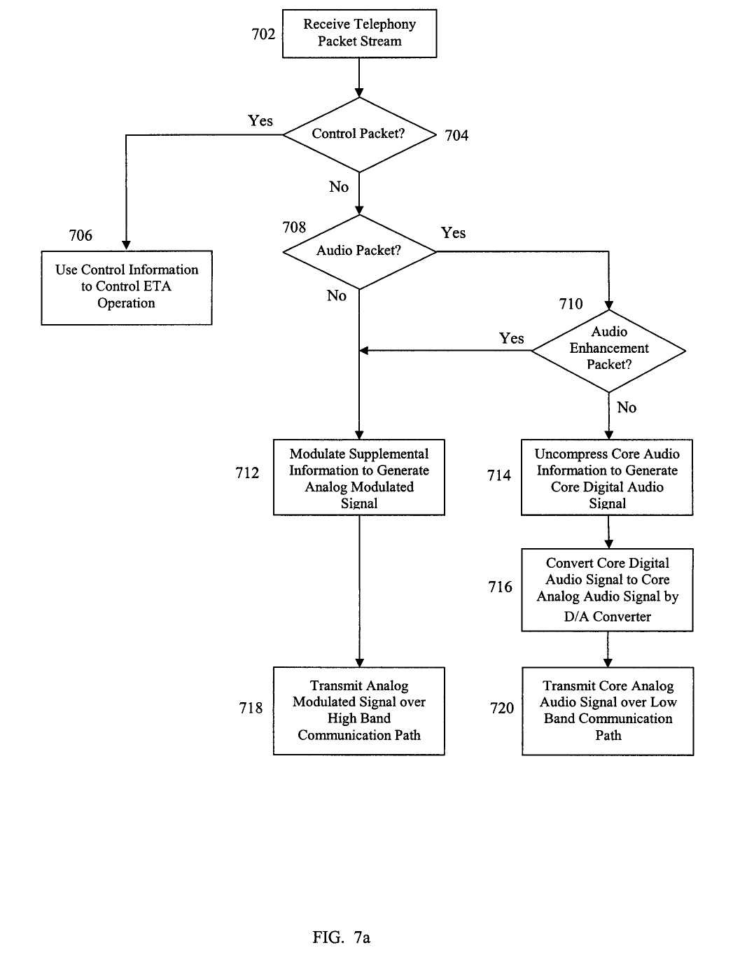

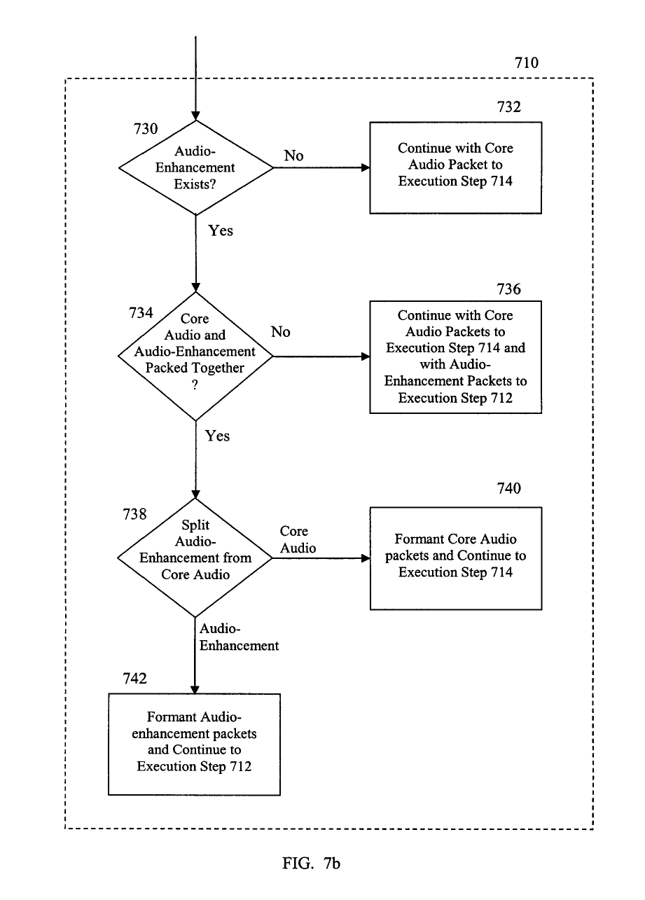

FIG. 7a illustrates a schematic flowchart of the operation of ETA 542. Telephony packet stream 548 is received in execution step 702 and its different components are separated in decision steps 704, 708 and 710. (See FIG. 7b for a detailed description of the operation of decision step 710.) Clearly, the order of separation of the components between decision steps 704, 708 and 710 is provided only for illustration and is irrelevant to the operation of ETA 542. Moreover, the core audio and audio-enhancement packets can be separated before the control packets, or a single-step three-way separating can also be used instead of the triple-step single-way separation illustrated in FIG. 7a. The control information is used for controlling the operation of ETA 542 in execution step 706. The core audio information is routed on one communication path while the supplemental information is routed on a second communication path. The core audio information is transmitted to audio Enc/Dec 622 and uncompressed in execution step 714 to generate core digital audio signal 614. The core digital audio signal is than transmitted to SLIC/SLAC 612 and is converted to core analog audio signal 608 in execution step 716 by the D/A converter in SLIC/SLAC 612. Core analog audio signal 608 is transmitted in execution step 720 over the low-band communication path, through ETA splitter 610, combined analog signal 604 and indoor twisted pair 136. The supplemental information is transmitted to ETA modem 620, where it is modulated to generate analog modulated signal 606 in execution step 712. Analog modulated signal 606 is transmitted in execution step 718 over the high-band communication path, also through ETA splitter 610, combined analog signal 604 and indoor twisted pair 136.

FIG. 7b provides further detailed description of decision step 710, which separates the core audio information from the audio-enhancement information. Since telephony packet stream 548 might not include audio-enhancement information, the existence of audio-enhancement information is first detected in decision step 730. If audio-enhancement information does not exist, execution step 732 continues with the core audio packets to execution step 714 (in FIG. 7a). If audio-enhancement information exists, decision step 734 determines if the core audio information and the audio-enhancement information are packed together or separately. If the core audio information and the audio-enhancement information are packed separately, execution step 736 continues with the core audio information packets to execution step 714 (in FIG. 7a) and the with the audio-enhancement information packets to execution step 712 (in FIG. 7a). If the core audio information and the audio-enhancement information are packed together, they are split in decision block 738. Further, execution step 740 continues with the core audio information packets to execution step 714 (in FIG. 7a) and execution step 742 continues with the audio-enhancement information packets to execution step 712 (in FIG. 7a).

FIG. 8 illustrates a schematic diagram of embedded IP phone (EIP) 554 in one embodiment of the present invention. For the sake of clarity of presentation, the term “signal” (or “stream”) is used to describe both the signals and the lines which carry these signals between one component to the other.

In the direction from the analog path (top to bottom), indoor twisted pair 136, as depicted in FIG. 5, is connected by combined analog signal 804 to EIP phone splitter 808, which splits combined analog signal 804 to core analog audio signal 810 and analog modulated signal 806. EIP phone splitter 808 operates, for example, according to Figure E.2/G.992.1 in ITU-T Recommendation G.992.1. Core analog audio signal 810 is received by EIP-FXO module 818, which operates similarly to Foreign Exchange Office (FXO) functionality of a standard analog telephone, by responding, for example, to ringing voltage and providing on-hook and off-hook indicators. EIP-FXO module 818 generates primary analog audio signal 826, which is received by audio combiner 842. EIP phone modem 816 receives and demodulates analog modulated signal 806 to generate supplemental information packet stream 822. EIP phone router 830 is configured to receive supplemental information packet stream 822 from EIP phone modem 816 and to extract and to send the different packet streams, which compose supplemental information packet stream 822, to their target destinations. Other-media packet stream 828 is sent to other terminals 838, protocol packet stream 824 to EIP phone controller 814 and audio-enhancement packet stream 832 to audio enhancement processor 834. Other terminals 838 can include, for example, a numerical keypad, a keyboard, a digital numerical display, a computer screen, a video screen or a video camera. Audio enhancement processor 834, which includes Enc/Dec circuitry and A/D+D/A converters, uncompresses the audio-enhancement information and converts it to audio-enhancement analog signal 836 using its D/A converter. Audio combiner 842 is connected to audio terminals 840 by mixed analog audio signal 844 and it can either pass the core audio information to audio terminals 840 (if the call does not include audio-enhancement information), or it can combine the core-audio information with the audio-enhancement information to generate the enhanced audio on mixed analog audio signal 844 for audio terminals 840.

In the direction to the analog path (bottom to top), if audio-enhancement information exists, audio combiner 842 separates the information received on mixed analog audio signal 844 to the core-audio information and to the audio-enhancement information. It passes the core audio information to EIP-FXO module 818 via primary analog audio signal 826 and the audio-enhancement information to audio enhancement processor 834 by audio-enhancement analog signal 836. If audio-enhancement information does not exist, audio combiner 842 only sends the core audio information to EIP-FXO module 818 via primary analog audio signal 826. EIP-FXO module 818 passes analog audio signal 826 to core analog audio signal 810. Audio enhancement processor 834 converts audio-enhancement analog signal 836 to a digital signal using its A/D converter and compresses it to create audio-enhancement packet stream 832. Other-media packet stream 828 received from other terminals 838, protocol packet stream 824 received from EIP phone controller 814 and audio-enhancement packet stream 832 are received by EIP phone router 830 to generate supplemental information packet stream 822. EIP phone modem 816 receives supplemental information packet stream 822 and modulate it to generate analog modulated signal 806. EIP phone splitter 808 receives core analog audio signal 810 and analog modulated signal 806 and combines them to generate combined analog signal 804, which is connected to indoor twisted pair 136.

EIP phone controller 814 is connected to all EIP phone modules by internal control lines 812. Although this connection is not explicitly depicted in FIG. 5, EIP phone 554 can also include direct connection by VoIP packet stream to router 450 in FIG. 5, or to conjoined-router/home 150 in FIG. 1 (similar to IP phone 154 by VoIP packet stream 152). In such a case VoIP packet stream 152 is connected to EIP phone router 830.

There are several possible operation modes for ETA 542 and EIP phone 554, where EIP phone 554 can operate as an analog telephone, an IP phone and in several EIP phone settings.

In one mode of operation, EIP phone receives only core analog audio signal from indoor twisted pair. In this mode of operation there is no high-band analog modulated signal and core analog audio signal 810 is identical to combined analog signal 804. In this configuration, EIP-FXO module 818 operates as the FXO circuitry of an analog telephone, connecting core analog audio signal 810 with audio terminals 840 (via primary analog audio signal 826, audio combiner 842 and mixed analog audio signal 844). In this mode of operation, EIP phone 554 operates as an analog telephone and can replace any of the analog telephones depicted, for example, in FIG. 1.

In yet a second mode of operation, EIP phone 554 can receive and transmit VoIP packet stream 152, which includes protocol packet stream 824, other-media packet stream 828 and audio packet stream 832. In that mode of operation, audio terminals 840 receive and send the analog audio to audio enhancement processor 834, via audio-enhancement analog signal 836, audio combiner 842 and mixed analog audio signal 844. In this mode of operation, all audio components are received, transmitted and processed by audio enhancement processor 834. In this mode, EIP phone 554 operates as an IP phone and can replace any IP telephony device depicted, for example, in FIG. 1.

In yet a third mode of operation, EIP phone 554 operates at an embedded fashion together with ETA 542. In this mode, the core audio information is received by EIP phone splitter 808 to EIP-FXO 818 for audio terminals 840. At the same time, supplemental information is also received by EIP phone splitter 808 to EIP phone modem 816 and to EIP phone router 830, where EIP phone router further distributes the protocol, other-media and audio-enhancement information to EIP phone controller 814, to other terminals 838 and to audio enhancement processor 834, respectively. The audio sent to audio terminals 840 can include the core audio information only, or can be a combination and mixing of the core audio information with the audio-enhancement information.

FIG. 9 illustrates a schematic flowchart of the operation of EIP phone 554 at that later embedded fashion mode. The core audio information is received on one communication path in execution step 904 and the supplemental information is received on another communication path in execution step 902. Although both types of information might be received on the same physical line, as depicted for EIP phone 554 in FIG. 5, the separation in execution steps 902 and 904 demonstrates that each information type is received on a different communication path. The supplemental information, which is received modulated, is first demodulated in execution step 906 and then the supplemental information is separated by EIP phone router 830 to audio-enhancement information, protocol information and other-media information in decision step 908. The other-media information is provided in execution step 918 to other terminals 838, such as video, graphical or other user-interfaced non-audio terminals. The protocol information is used for the control of EIP phone 554. The audio-enhancement information is uncompressed in execution step 910 and is combined with the core audio information in execution step 916. The combined audio information is provided to audio terminals 840 in execution step 922 to play out the audio for the user of EIP phone 554. Obviously, if audio-enhancement information does not exist in the media-session information, execution step 910 is not executed and the core audio information is simply passed through in execution step 916. In such a case, the combined audio information consists only on the core audio information.

The packets on core audio packet path 630 can include coded wideband audio, ETA audio Enc/Dec 622 can include wideband uncompressing and compressing functionalities and SLIC/SLAC 612 can include wideband D/A and wideband A/D. To allow complete wideband path, all low-pass filters in the system (such as in ETA splitter 610, in EIP phone splitter 808 and low-pass filter 434 and 438) need to be modified to allow the full spectral content of wideband audio to pass through the analog path. In such a case, the spectral content of analog modulated signal 606 might needs to be modified to avoid overlap or leakage into the spectrum of core analog audio signal 608 by using a higher cutoff frequency as the lowest modulation frequency. The setting of the cutoff frequency is done relatively to the bandwidth of the core audio, such that the cutoff frequency is the lowest possible, but yet bounded below by the spectral band of the core audio. For example, if narrowband core audio (up to 4 KHz) is used, the lowest cutoff frequency can be F₁, while if wideband audio (up to 8 KHz) is used, the lowest cutoff frequency might need to be increased to F₂, where F₁<F₂. Assuming that a modulation protocol similar to DSL is used for digital communication between ETA 542 and EIP phone 554, this increase in the cutoff frequency can be achieved, for example, by disabling one or several lower frequency DSL channels (each of 4.3125 KHz bandwidth). The change in the cutoff frequency can be fixed or programmable. Since low-pass filter 434 and 438 are typically not programmable, they can be set or manufactured to the lowest possible value of the cutoff frequency, such as 4 KHz. ETA splitter 610 and EIP phone splitter 808 can be programmable by ETA controller 618 and EIP controller 814, respectively, allowing dynamic bandwidth allocation between the core audio signal and the modulated data signal. In such a case, the users of analog telephones 132 and 140 will perceive the call as a narrowband call while the user of EIP phone 554 will perceive the call as a wideband call. The natural call transfer and conferencing between all telephony devices will be maintained in that case.

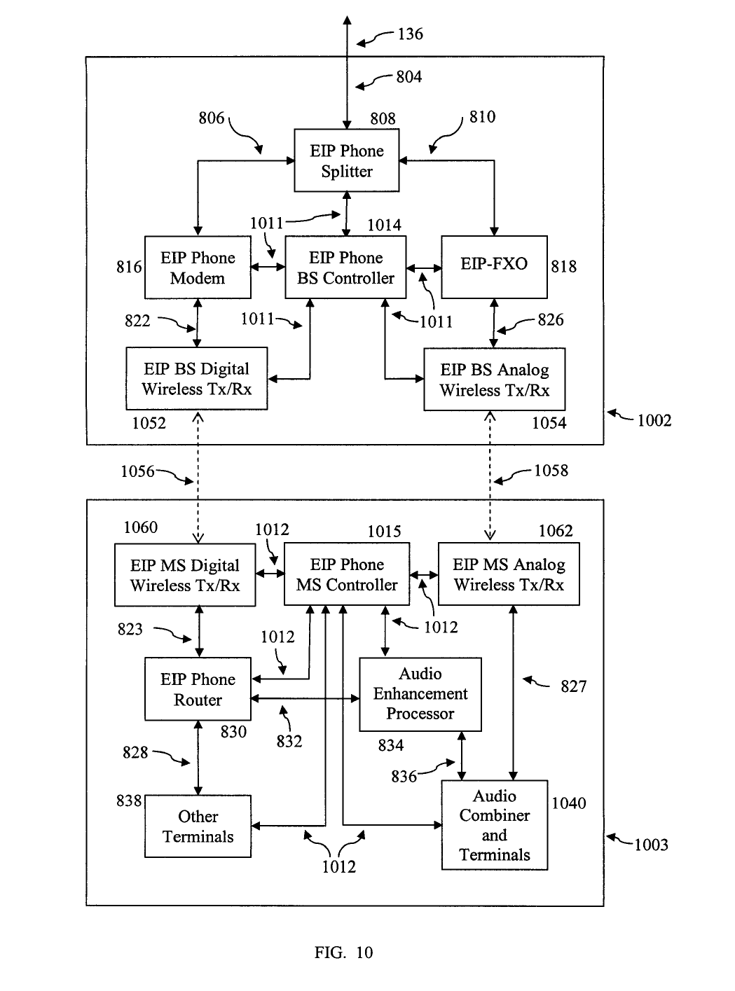

EIP phone device can also be implemented as a mobile wireless system. A mobile wireless system includes a Base Station (BS) device and a Mobile Station (MS) device which communicate wirelessly with each other. The separation of the processing modules and the communication functionalities between the BS device and the MS device can be done according to several criteria, such as costs, complexity of design, physical spaces, battery power and others. FIG. 10 illustrates a schematic diagram of a mobile wireless EIP phone system in one embodiment of the present invention. The EIP phone modules were separate between EIP phone BS 1002 and EIP phone MS 1003, where several modules were added the basic EIP phone to enable wireless operation. EIP phone BS 1002 includes EIP phone splitter 808, EIP phone modem 816, EIP-FXO 818 and EIP phone BS controller 1014. EIP phone BS 1002 also includes EIP BS digital wireless Transmit/Receive (Tx/Rx) 1052 and EIP BS analog wireless Tx/Rx 1054. EIP phone MS 1003 includes EIP phone router 830, audio enhancement processor 834, other terminals 838, audio combiner and terminals 1040 and EIP phone MS controller 1015. EIP phone MS 1003 also includes EIP MS digital wireless Tx/Rx 1060 and EIP MS analog wireless Tx/Rx 1062. The operation of EIP phone splitter 808, EIP phone modem 816, EIP-FXO 818, EIP phone router 830, audio enhancement processor 834 and other terminals 838 in EIP phone BS 1002 and EIP phone MS 1003 are equivalent to the operation of their counterparts in EIP phone 554 described in FIG. 8. The operation of audio combiner and terminals 1040 is equivalent to the joint operation of audio combiner 842 and audio terminals 840 in FIG. 8. The functionality of EIP phone controller 814 was split between EIP phone BS controller 1014 and EIP phone MS controller 1015, which control EIP phone BS 1002 and EIP phone MS 1003 by internal control lines 1011 and 1012, respectively. EIP BS digital wireless Tx/Rx 1052 communicates via wireless digital channel 1056 with EIP MS digital wireless Tx/Rx 1060, connecting BS supplemental information packet stream 822 with MS supplemental information packet stream 823. EIP BS analog wireless Tx/Rx 1054 connects via wireless analog channel 1058 with EIP MS analog wireless Tx/Rx 1062, connecting BS primary analog audio path 826 with MS primary analog audio path 827. Note that wireless analog channel 1058 can include sampling of the analog audio signals (from BS primary analog audio path 826 and in MS primary analog audio path 827) with A/D converters, digital processing and encoding of the audio, digital transmission and decoding and finally converting to analog audio signals (to BS primary analog audio path 826 and in MS primary analog audio path 827) by D/A converters, similar to commercially available cordless phones.

In yet another embodiment of a wireless EIP phone system, audio enhancement processor 834 might be placed inside EIP phone BS 1002, which can save battery life for EIP phone MS 1003. In such a case, it is assumed that EIP BS analog wireless Tx/Rx 1054 includes an element to combine the core audio information received from EIP-FXO 818 and the audio-enhancement received from audio enhancement processor 834, and that wireless analog channel 1058 is capable of transmitting the combined audio signal to EIP phone MS 1003.

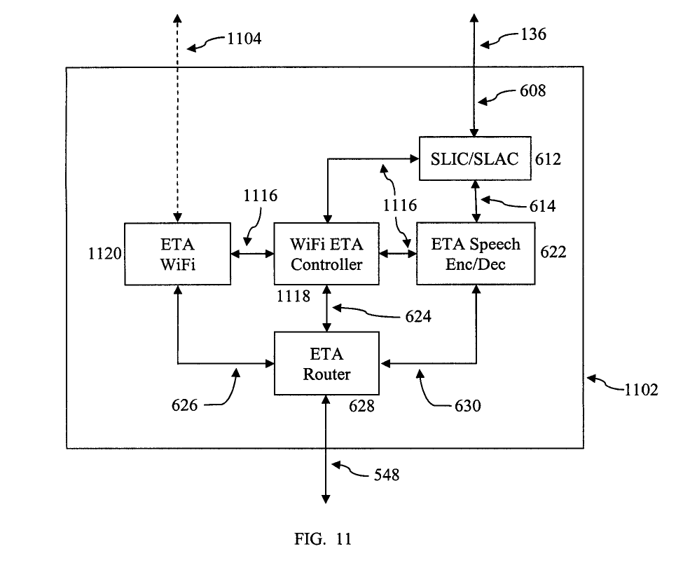

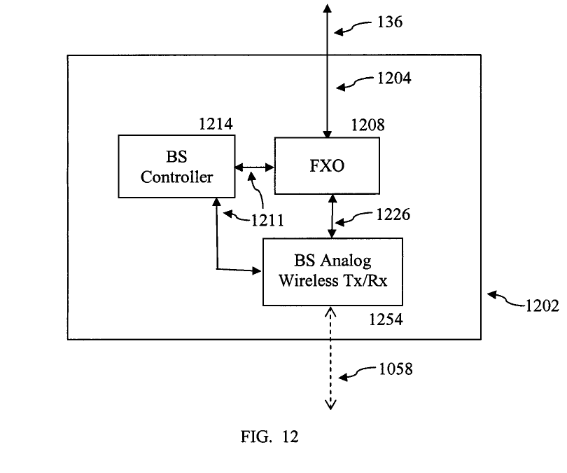

Several wireless protocols can be used for wireless digital channel 1056. If EIP phone MS 1003 uses WiFi wireless protocol in its EIP MS digital wireless Tx/Rx 1060 module, both ETA 542 and EIP phone BS 1002 can take a simplified form to operate with EIP phone MS 1003. This configuration is described in FIGS. 11 and 12. FIG. 11 illustrates a schematic diagram of an embedded telephony adapter with WiFi module in one embodiment of the present invention. Similar to ETA 542 described in FIG. 6, WiFi ETA 1102 includes ETA router 628, ETA audio Enc/Dec 622, SLIC/SLAC 612 and WiFi ETA controller 1118. However, SLIC/SLAC 612 in FIG. 11 generates/receives core analog audio signal 608 directly to/from indoor twisted pair 136 without the interface of ETA splitter 610 depicted in FIG. 6. ETA modem 620 in FIG. 6 is replaced by ETA WiFi module 1120, which communicates wirelessly via digital wireless WiFi Tx/Rx 1104. FIG. 12 illustrates a schematic diagram of a wireless BS 1202, which uses FXO module 1208, BS controller 1214 and BS analog wireless Tx/Rx 1254 in one embodiment of the present invention. Wireless BS 1202 provides only one wireless connection via wireless analog channel 1058 and its structure is identical to the structure of common wireless base stations currently used for home cordless phones, such as DECT. In this embodiment of the present invention, EIP phone MS 1003 communicates the core audio information using wireless connection which is similar or identical to common cordless telephony. The digital information to EIP phone MS 1003, which can include supplemental information, is communicated via the WiFi connection.

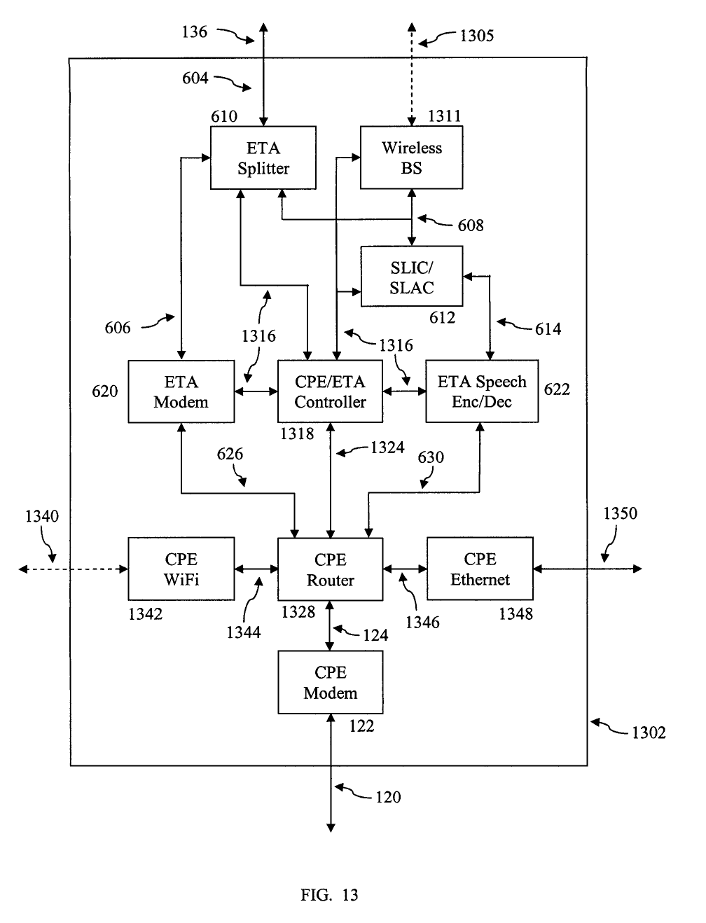

The distribution functionalities of a conjoined telephony system can be integrated within a CPE device, including wireline and wireless packet streams and analog signals. FIG. 13 illustrates a schematic diagram of an integrated CPE device with an integrated ETA in one embodiment of the present invention. Integrated CPE device 1302 is connected to broadband connection 120. The broadband carrier signals are demodulate and decoded by modem 122 into local packet data stream 124, which is communicated with CPE router 1328. The packet data is distributed by CPE router 1328 to other modules according to their target destination. WiFi packet stream 1344 is routed to CPE WiFi module 1342, Ethernet packet stream 1346 is routed to CPE Ethernet module 1348, supplemental information packets on supplemental information packet path 626 are routed to ETA modem 620, control packet stream 1324 is routed to CPE/ETA controller 1318 and core audio packets on core audio packet path 630 are routed to ETA audio Enc/Dec 622. CPE Ethernet module 1348 is connected to wireline Ethernet connection path 1350 and CPE WiFi module 1342 uses radio for wireless WiFi connection path 1340. The operation of ETA modem 620, audio Enc/Dec 622, SLIC/SLAC 612 and ETA splitter 610, together with analog modulated signal 606, core digital audio signal 614, core analog audio signal 608 and combined analog signal 604, are identical to the operation of their corresponding modules or signals in FIG. 6. CPE/ETA controller 1318 use control lines 1316 (for simplicity not all shown in FIG. 13) to control all the modules of CPE device 1302. Wireless BS 1311 is connected to core analog audio signal 608 and provides cordless channel 1305. CPE device 1302 might include other modules and connections, such as routing of digital television packet stream to IP TV devices, which are not depicted in FIG. 13. In addition to data routing to various devices or computers via wireline Ethernet connection path 1350 or wireless WiFi connection path 1340, CPE device 1302 can provide all flavors of conjoined or conjoined/embedded telephony discussed above. Analog telephones can be connected via indoor twisted pair 136 to combined analog signal 604, cordless phones can use cordless channel 1305, IP phones can use wireline Ethernet connection path 1350, WiFi phones can use wireless WiFi connection path 1340 and EIP phones can use either wireline (such as indoor twisted pair 136 or Ethernet connection path 1350) or wireless (such as cordless channel 1305 or WiFi connection path 1340) connections. In addition, CPE device 1302 can use any combination of connections to provide conjoined or conjoined/embedded telephony. For example, an analog telephone and a wireline EIP phone connected via indoor twisted pair 136 to combined signal 604, a cordless phone connected to cordless channel 1305 or a wireless EIP phone connected to both cordless channel 1305 and wireless WiFi connection 1340 can all operate in receiving, transferring, or participating on the same call, without a need for special conferencing operation for the audio, while providing audio-enhancement and/or data features to both EIP phones. Other enhancement features are also possible, such as using analog telephones with one telephone number, IP phone or EIP phone with a second telephone number and conjoined call of all telephones with yet a third telephone number.

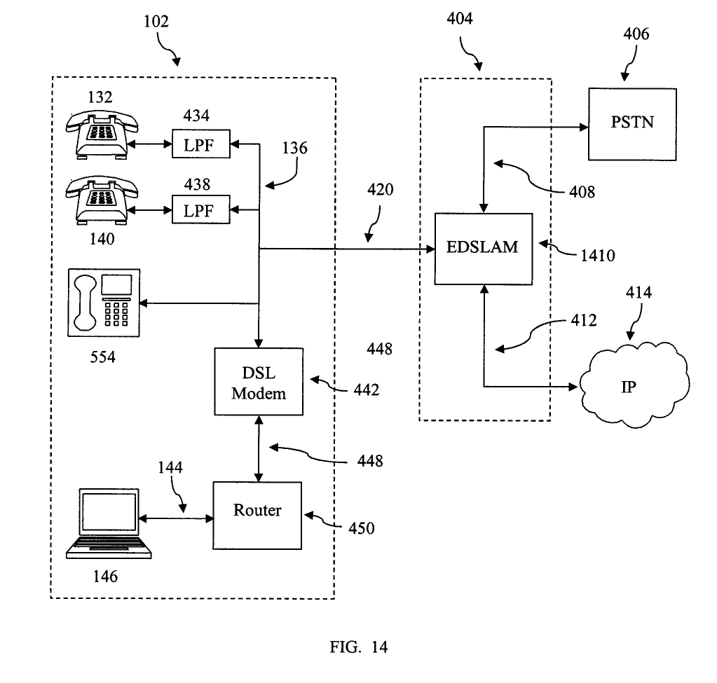

If the home/home-office uses DSL technology for its broadband connection, the embedded conjoined telephony can be implemented in the telephone exchange without the use of an ETA in the home/home-office. FIG. 14 illustrates a schematic diagram of an embedded telephony adapter implemented as an embedded DSLAM in the telephony exchange in one embodiment of the present invention. Telephone exchange 404, as depicted in FIG. 14, uses embedded DSLAM (EDSLAM) 1410. EDSLAM receives the call-session information either from PSTN network 406 or from IP network 414. Similar to ETA 542, it extracts the core audio information and sends it over the low band of outdoor twisted pair 420 and it extracts the supplemental information and sends it over the high band of outdoor twisted pair 420. Outdoor twisted pair is connected to indoor twisted pair 136, which provides the embedded conjoined telephony to analog telephones 132 and 140 and to EIP phone 554. This configuration can be in particularly suitable for Very high speed DSL (VDSL), where EIP phone modem 816 in EIP phone 554 (see FIG. 8) is simply configured as one of several VDSL terminals, while DSL modem 442 is configured as another VDSL terminal.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. For example, it is contemplated that the circuitry disclosed herein can be implemented in software, or vice versa. The described embodiments are to be considered in all respects as illustrative and not restrictive. It should also be understood that the invention is not limited to the particular embodiments described herein, but is capable of many rearrangements, modifications, and substitutions without departing from the scope of the invention.

I claim:

1. A communication method comprising:
receiving a first single-targeted call-initiation request at a conjoined-router;
generating a second single-targeted call-initiation request by said conjoined-router in response to said first single-targeted call-initiation request; and
generating a third single-targeted call-initiation request by said conjoined-router in response to said first single-targeted call-initiation request;

2. The method of claim 1, wherein at least one of said first single-targeted call-initiation request, said second single-targeted call-initiation request and said third single-targeted call-initiation request is in conformity with Session Initiation Protocol (SIP).

3. The method of claim 1, wherein at least one of said first single-targeted call-initiation request, said second single-targeted call-initiation request and said third single-targeted call-initiation request is in conformity with H.323 protocol.

4. The method of claim 1, wherein at least one of said second single-targeted call-initiation request and said third single-targeted call-initiation request uses at least one Foreign Exchange Station (FXS) electrical signal.

5. The method of claim 1, wherein said first single-targeted call-initiation request is in conformity with a first call-initiation protocol and said second single-targeted call-initiation request is in conformity with a second call-initiation protocol and said method further comprising converting said first call-initiation protocol to said second call-initiation protocol.

6. The method of claim 1, further comprising receiving said second single-targeted call-initiation request at a first telephony device and receiving said third single-targeted call-initiation request at a second telephony device.

7. The method of claim 6, further comprising establishing a two-way media session in response to receiving an acceptance message from said first telephony device.

8. The method of claim 7, further comprising establishing a three-way media session in response to receiving an acceptance message from said second telephony device.

9. The method of claim 8, further comprising terminating said three-way media session in response to receiving a call-termination message.

10. The method of claim 6, further comprising establishing a three-way media session in response to simultaneously receiving a first acceptance message from said first telephony device and receiving a second acceptance message from said second telephony device.

11. The method of claim 10, further comprising terminating said three-way media session in response to receiving a call-termination message.

12. A conjoined-router, said conjoined-router comprising:
a processing circuit configured to receive a first single-targeted call-initiation request, to generate a second single-targeted call-initiation request in response to said first single-targeted call-initiation request and to generate a third single-targeted call-initiation request in response to said first single-targeted call-initiation request.

13. The conjoined-router of claim 12, wherein said processing circuit is further configured to receive said first single-targeted call-initiation request in conformity with SIP.

14. The conjoined-router of claim 12, wherein said processing circuit is further configured to receive said first single-targeted call-initiation request in conformity with H.323 protocol.

15. The conjoined-router of claim 12, wherein said processing circuit is further configured to generate said second single-targeted call-initiation request in conformity with SIP.

16. The conjoined-router of claim 12, wherein said processing circuit is further configured to generate said second single-targeted call-initiation request in conformity with H.323 protocol.

17. The conjoined-router of claim 12, wherein said processing circuit is further configured to generate said second single-targeted call-initiation request using at least one FXS electrical signal.

18. A communication method comprising:
receiving call-session information;
separating said call-session information into core audio information and into supplementary information;
routing said core audio information on a first path; and
routing said supplemental information on a second path.

19. The method of claim 18, wherein said supplemental information comprises of protocol information.

20. The method of claim 18, wherein said supplemental information comprises of other-media information.

21. The method of claim 18, wherein said supplemental information comprises of audio-enhancement information.

22. The method of claim 18, further comprising uncompressing said core audio information to generate core digital audio signal.

23. The method of claim 22, further comprising converting said core digital audio signal to core analog audio signal.

24. The method of claim 23, further comprising transmitting said core analog audio signal in a spectral band below a predetermined cutoff frequency.

25. The method of claim 24, further comprising setting said predetermined cutoff frequency bounded below by the spectral band of said core audio information.

26. The method of claim 23, further comprising transmitting said core analog audio signal over a wireless channel.

27. The method of claim 18, further comprising modulating said supplemental information to generate an analog modulated signal.

28. The method of claim 27, further comprising transmitting said analog modulated signal in a spectral band above a predetermined cutoff frequency.

29. The method of claim 27, further comprising transmitting said analog modulated signal over a wireless channel.

30. An embedded telephony adaptor device, comprising:
a router configured to receive a call-session information on a receiving path, to separate said call-session information to core audio information and supplemental information, to route said core audio information on one path and to route said supplemental information on a second path.

31. The embedded telephony adaptor device of claim 30, further comprising an audio Enc/Dec device in communication with said router to uncompress said core audio information to generate core digital audio signal.

32. The embedded telephony adaptor device of claim 31, further comprising a D/A converter device in communication with said Encoder/Decoder (Enc/Dec) device to convert said core digital audio signal to a core analog audio signal.

33. The embedded telephony adaptor device of claim 32, further comprising a splitter in communication with said Digital-to-Analog (D/A) converter device to transmit said core analog audio signal on a low spectral band.

34. The embedded telephony adaptor device of claim 30, further comprising:
a modem in communication with said router to modulate said supplemental information to generate analog modulated signal; and
a splitter in communication with said modem to transmit said analog modulated signal on a high spectral band.

35. A communication method, comprising:
receiving core audio information on a first communication path in a telephony device;
receiving supplemental information on a second communication path in said telephony device;
providing said core audio information to audio terminals in said telephony device;
extracting other-media information from said supplemental information; and
providing said other-media information to other terminals in said telephony device.

36. A communication method, comprising:
receiving core audio information on a first communication path;
receiving audio-enhancement information on a second communication path;
uncompressing said audio-enhancement information;
combining core audio information with audio-enhancement information to generate combined audio information; and
providing said combined audio information to audio terminals.

37. An embedded Internet Protocol (IP) phone device, comprising:
a splitter circuitry configured to receive a combined analog signal and to split said combined analog signal to a core analog audio signal an analog modulated signal;
a Foreign Exchange Office (FXO) circuitry in communication with said splitter to receive said core analog audio signal;
a modem circuitry in communication with said splitter to receive said analog modulated signal and to demodulate said analog modulated signal to generate supplemental information packet stream.

38. The embedded IP phone device of claim 37, further comprising audio combiner in communication with said FXO circuitry to receive said core analog audio signal.

39. The embedded IP phone device of claim 37, further comprising router in communication with said modem circuitry to receive and separate said supplemental information packet stream to other-media packet stream, protocol packet stream and audio-enhancement packet stream.

40. The embedded IP phone device of claim 39, further comprising audio enhancement processing circuitry in communication with said router to receive and uncompress said audio-enhancement packet stream to generate audio-enhancement analog signal.

41. The embedded IP phone device of claim 40, further comprising audio combiner in communication with said audio enhancement processing circuitry and in communication with said FXO circuitry to receive and combine said core analog audio signal and said audio-enhancement analog signal.
